(19) United States
(12) Patent Application Publication
(10) Pub. No.: US 2024/0409003 A1
(43) Pub. Date: Dec. 12, 2024

(54) VEHICLE AND METHOD FOR CONTROLLING VEHICLE

(71) Applicant: TOYOTA JIDOSHA KABUSHIKI KAISHA, Toyota-shi (JP)

(72) Inventors: Keisuke UKITA, Toyoake-shi (JP); Yusuke KURUMA, Toyota-shi (JP); Tsubasa MIGITA, Sakai-shi (JP); Kei MORIKAWA, Toyota-shi (JP); Yasumasa OGUMA, Nagoya-shi (JP)

(73) Assignee: TOYOTA JIDOSHA KABUSHIKI KAISHA, Toyota-shi (JP)

(21) Appl. No.: 18/648,665

(22) Filed: Apr. 29, 2024

(30) Foreign Application Priority Data
Jun. 7, 2023 (JP) 2023-093881

(51) Int. Cl. B60L 58/18; B60L 58/14

(52) U.S. Cl. CPC B60L 58/18; B60L 58/14

(57) ABSTRACT

When an ECU determines that a gas concentration within a battery pack is increasing, the ECU performs processing including: obtaining positional information; obtaining an amount of insolation; and performing gas exhaust processing when the ECU determines that a vehicle is traveling, determines that the position of the vehicle is a position where there is no cover above the vehicle, and determines that the position of the vehicle is a position where exhaust has no influence.

### CROSS REFERENCE TO RELATED APPLICATIONS

This nonprovisional application is based on Japanese Patent Application No. 2023-093881 filed on Jun. 7, 2023 with the Japan Patent Office, the entire contents of which are hereby incorporated by reference.

### BACKGROUND OF THE DISCLOSURE

### Field of the Disclosure

The present disclosure relates to a vehicle.

### Description of the Background Art

For example, Japanese Patent Laying-Open No. 2022-012308 discloses a technique of prohibiting driving of a cooling device when the concentration of a gas containing hydrogen sulfide within a battery pack is higher than a threshold value, to suppress exhaust to an outside of a vehicle.

### SUMMARY OF THE DISCLOSURE

However, when exhaust to the outside of the vehicle is suppressed, the battery pack is filled with the gas, and thus it may be required to exhaust the gas within the battery pack to the outside of the vehicle at appropriate timing.

An object of the present disclosure is to provide a vehicle that can exhaust a gas within a battery pack at appropriate timing, and a method for controlling the vehicle.

A vehicle according to an aspect of the present disclosure includes: a battery pack having a secondary battery; an exhaust device configured to exhaust a gas generated from the secondary battery within the battery pack to an outside of the vehicle; a detection device that detects at least one of a position of the vehicle and a traveling state of the vehicle; and a control device that controls the exhaust device to exhaust the gas to the outside of the vehicle when a detection result of the detection device is a predetermined detection result.

With such a configuration, since the exhaust device is controlled to exhaust the gas to the outside of the vehicle when a detection result of the traveling state of the vehicle or the position of the vehicle is a predetermined detection result, the gas within the battery pack can be exhausted at appropriate timing.

In the present embodiment, the detection device detects a vehicle speed. The control device controls the exhaust device to exhaust the gas to the outside of the vehicle when the detected vehicle speed indicates that the vehicle is traveling, and not to exhaust the gas to the outside of the vehicle when the detected vehicle speed indicates that the vehicle is in a stopped state.

With such a configuration, since the gas is exhausted to the outside of the vehicle when the vehicle is traveling, and the exhausted gas is diffused without stay, the amount of gas within the battery pack can be decreased without having an influence on the surroundings of the vehicle. Further, since exhaust of the gas to the outside of the vehicle is suppressed when the vehicle is in a stopped state, stay of the gas around the vehicle is suppressed.

Further, in the present embodiment, the control device controls the exhaust device to exhaust the gas to the outside of the vehicle when it is detected that the position of the vehicle is within a first region, and not to exhaust the gas to the outside of the vehicle when it is detected that the position of the vehicle is within a second region different from the first region. The first region is preset as a region with a degree of influence caused by exhaust of the gas lower than that in the second region.

With such a configuration, since the gas is exhausted to the outside of the vehicle when the position of the vehicle is within the first region, the amount of gas within the battery pack can be decreased without having an influence on the surroundings of the vehicle. On the other hand, since the gas is not exhausted to the outside of the vehicle when the position of the vehicle is within the second region, stay of the gas around the vehicle within the second region is suppressed.

Further, in the present embodiment, the control device controls the exhaust device to exhaust the gas to the outside of the vehicle when the position of the vehicle is a position where there is no cover above the vehicle, and not to exhaust the gas to the outside of the vehicle when the position of the vehicle is a position where there is a cover above the vehicle.

With such a configuration, since the gas is exhausted to the outside of the vehicle when the position of the vehicle is a position where there is no cover above the vehicle, the gas is diffused without stay around the vehicle, and thus the amount of gas within the battery pack can be decreased without having an influence on the surroundings of the vehicle. On the other hand, since the gas is not exhausted to the outside of the vehicle when the position of the vehicle is a position where there is a cover above the vehicle, stay of the gas around the vehicle is suppressed.

Further, in the present embodiment, the battery pack includes an all-solid-state battery. The gas contains hydrogen sulfide.

With such a configuration, the gas generated in the all-solid-state battery within the battery pack can be exhausted to the outside of the vehicle at appropriate timing, using the detection result of the traveling state of the vehicle or the position of the vehicle.

A method for controlling a vehicle according to another aspect of the present disclosure is a method for controlling a vehicle equipped with a battery pack having a secondary battery. The vehicle includes an exhaust device configured to exhaust a gas generated from the secondary battery within the battery pack to an outside of the vehicle. The method includes: detecting at least one of a position of the vehicle and a traveling state of the vehicle; and controlling the exhaust device to exhaust the gas to the outside of the vehicle when a detection result is a predetermined detection result.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a view showing an example of a configuration of a vehicle according to the present embodiment.

FIG. 2 is a flowchart showing an example of processing performed by an ECU.

FIG. 3 is a view for illustrating a gas exhaust path.

### DESCRIPTION OF THE PREFERRED EMBODIMENTS

Hereinafter, an embodiment of the present disclosure will be described in detail with reference to the drawings. It should be noted that identical or corresponding parts in the drawings will be designated by the same reference numerals, and the description thereof will not be repeated.

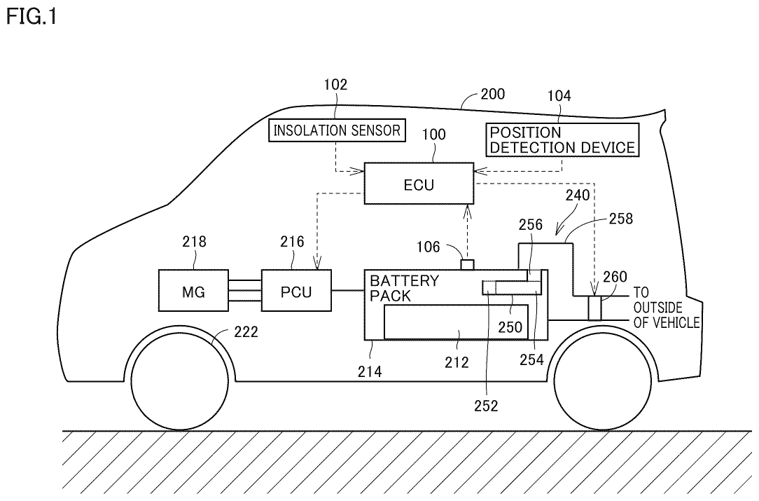

In the following, a case where a vehicle 200 according to the present embodiment is an electric car will be described as an example. FIG. 1 is a view showing an example of a configuration of vehicle 200 according to the present embodiment. It should be noted that vehicle 200 is not particularly limited as long as it is a vehicle equipped with a battery pack, and may be a hybrid car, a plug-in hybrid car, or a fuel cell car.

As shown in FIG. 1, vehicle 200 includes an electronic control unit (ECU) 100, an insolation sensor 102, a position detection device 104, a concentration sensor 106, a battery pack 214, a power control unit (PCU) 216, a motor generator (MG) 218, drive wheels 222, and an exhaust device 240.

MG 218 is typically an alternating current (AC) rotating electric machine, and is, for example, a three-phase AC synchronous electric motor including a rotor having a permanent magnet embedded therein. MG 218 has a function as an electric motor (motor) and a function as a power generator (generator). An output torque of MG 218 is transmitted to drive wheels 222 via a reduction gear, a differential gear, and the like.

During braking of vehicle 200, MG 218 is driven by drive wheels 222, and MG 218 operates as a power generator. Thereby, MG 218 also functions as a braking device that performs regenerative braking for converting kinetic energy of vehicle 200 into electric power. Regenerative power generated by a regenerative braking force in MG 218 is stored in battery pack 214.

PCU 216 is a power conversion device configured to bidirectionally convert electric power between MG 218 and battery pack 214. PCU 216 includes an inverter and a converter that operate based on a control signal from ECU 100, for example.

When battery pack 214 is discharged, the converter boosts a voltage supplied from battery pack 214, and supplies it to the inverter. The inverter converts direct current (DC) power supplied from the converter into AC power, and drives MG 218.

In contrast, when battery pack 214 is charged, the inverter converts AC power generated by MG 218 into DC power, and supplies it to the converter. The converter bucks a voltage supplied from the inverter to a voltage suitable for charging battery pack 214, and supplies it to battery pack 214.

In addition, PCU 216 stops charging/discharging of battery pack 214 by stopping operation of the inverter and the converter based on a control signal from ECU 100. It should be noted that PCU 216 may be configured not to have a converter.

Battery pack 214 is a power storage device that stores electric power for driving MG 218. Battery pack 214 is a rechargeable DC power source, and includes a battery module 212 composed of a plurality of cells connected in series, for example. Each cell is a secondary battery in which a solid electrolyte is used for migration of ions between a positive electrode and a negative electrode, and is an all-solid-state battery in which constituent members thereof are all solid. As a material constituting the cell, any material known as a material constituting an all-solid-state battery may be used, and as the solid electrolyte, a sulfide-based material such as sulfide glass may be used, for example. The solid electrolyte may include at least one selected from the group consisting of Li₂S—P₂S₅, Li₂S—SiS₂, LiI—Li₂S—SiS₂, LiI—Si₂S—P₂S₅, LiI—LiBr—Li₂S—P₂S₅, LiI—Li₂S—P₂S₅, LiI—Li₂O—Li₂S—P₂O₅, LiI—Li₂S—P₂S₅, LiI—Li₃PO₄—P₂S₅, and Li₂S—P₂S₅—GeS₂, for example.

Exhaust device 240 is configured to exhaust a gas generated within battery pack 214 to an outside of the vehicle. Exhaust device 240 includes a first exhaust duct 250, a second exhaust duct 258, and a shutter mechanism 260.

First exhaust duct 250 is provided inside battery pack 214. An opening is formed at one end of first exhaust duct 250. The opening is provided immediately above battery module 212, and is provided toward an upper part of battery pack 214. The other end of first exhaust duct 250 is connected to an upper opening in a case (casing) for battery pack 214, and is connected to one end of second exhaust duct 258. A first filter 252 is provided to a passage on the side of the one end of first exhaust duct 250. A second filter 256 is provided to a passage on the side of the other end of first exhaust duct 250. A desulfurization agent 254 for adsorbing a sulfur component in the gas is provided to a passage between first filter 252 and second filter 256 in first exhaust duct 250.

The one end of second exhaust duct 258 is connected with the other end of first exhaust duct 250, as described above. The other end of second exhaust duct 258 is connected to an opening (not shown) to the outside of the vehicle. Shutter mechanism 260 is provided between the one end and the other end of second exhaust duct 258. Shutter mechanism 260 is configured, for example, to switch between a cut-off state in which it cuts off gas flow by closing a flow path in second exhaust duct 258 using an actuator (not shown) driven according to a control signal from ECU 100, and a flowable state in which it allows the gas to flow by opening the flow path. It should be noted that second exhaust duct 258 is further provided with a fan (not shown) for forcibly exhausting the gas within battery pack 214 to the outside of the vehicle.

Insolation sensor 102, position detection device 104, and concentration sensor 106 are connected to ECU 100.

Insolation sensor 102 is provided such that it can receive insolation through a windshield, for example. Insolation sensor 102 detects the amount of insolation (the amount of heat or the amount of energy) per unit time received by a light receiving surface, for example. Insolation sensor 102 may be provided on the roof of vehicle 200, for example. Insolation sensor 102 outputs a signal indicating the detected amount of insolation to ECU 100.

Position detection device 104 detects positional information of vehicle 200, and outputs a signal indicating the detected positional information to ECU 100. It should be noted that position detection device 104 may be a receiver that receives a signal indicating positional information from a satellite for position detection for a global positioning system (GPS) or the like, or a receiver that receives a signal indicating positional information from a base station around vehicle 200 for a wireless local area network (LAN) or the like, for example.

Concentration sensor 106 detects a gas concentration within battery pack 214. More specifically, concentration sensor 106 may detect the concentration of hydrogen sulfide contained in the gas as a gas concentration, and output a signal indicating the detected gas concentration to ECU 100, for example.

ECU 100 includes a central processing unit (CPU), and a memory (a read only memory (ROM) and a random access memory (RAM)). ECU 100 controls the devices (for example, PCU 216 and shutter mechanism 260 of exhaust device 240 described later) such that vehicle 200 achieves a desired state, based on a signal received from each sensor and information such as maps and programs stored in the memory.

Since battery pack 214 mounted in such vehicle 200 includes battery module 212 which is a sulfide-based all-solid-state battery, if the gas containing the sulfur component flows out of a cell constituting battery module 212, hydrogen sulfide may be generated by a reaction between the sulfur component and moisture contained in the air within battery pack 214.

Accordingly, for example, when the gas concentration within battery pack 214 is higher than a threshold value, it is also conceivable to suppress exhaust to the outside of the vehicle. However, when exhaust to the outside of the vehicle is suppressed, battery pack 214 is filled with the gas, and thus it may be required to exhaust the gas within battery pack 214 to the outside of the vehicle at appropriate timing.

Therefore, in the present embodiment, ECU 100 is configured to control the exhaust device to exhaust the gas to the outside of the vehicle when a detection result of at least one of a position of vehicle 200 and a traveling state of vehicle 200 is a predetermined detection result.

For example, ECU 100 is configured to control exhaust device 240 to exhaust the gas to the outside of the vehicle when a detected vehicle speed indicates that vehicle 200 is traveling, and not to exhaust the gas to the outside of the vehicle when the detected vehicle speed indicates that vehicle 200 is in a stopped state.

With such a configuration, since the gas is exhausted to the outside of the vehicle when vehicle 200 is traveling, and the exhausted gas is diffused without stay, the amount of gas within battery pack 214 can be decreased without having an influence on the surroundings of vehicle 200. Further, since exhaust of the gas to the outside of the vehicle is suppressed when vehicle 200 is in a stopped state, stay of the gas around vehicle 200 is suppressed. Thus, the gas within battery pack 214 can be exhausted at appropriate timing.

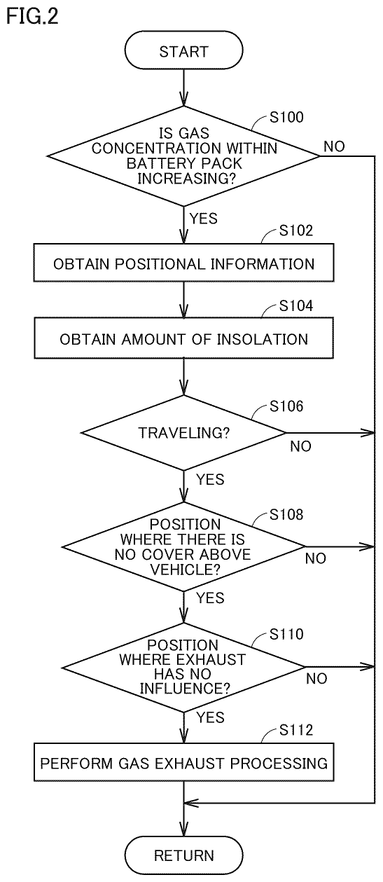

In the following, an example of processing performed by ECU 100 will be described with reference to FIG. 2. FIG. 2 is a flowchart showing an example of processing performed by ECU 100. A series of processing shown in this flowchart is performed repeatedly at every predetermined cycle.

In step (hereinafter referred to as S) 100, ECU 100 determines whether or not the gas concentration within battery pack 214 is increasing. For example, ECU 100 may determine that the gas concentration within battery pack 214 is increasing when the gas concentration within battery pack 214 detected by concentration sensor 106 exceeds a threshold value, or may determine that the gas concentration within battery pack 214 is increasing when the amount of change per unit time of the gas concentration exceeds a threshold value. When it is determined that the gas concentration within battery pack 214 is increasing (YES in S100), the processing proceeds to S102.

In S102, ECU 100 obtains positional information from position detection device 104. Then, the processing proceeds to S104.

In S104, ECU 100 obtains the amount of insolation from insolation sensor 102. Then, the processing proceeds to S106.

In S106, ECU 100 determines whether or not vehicle 200 is traveling. For example, ECU 100 determines that vehicle 200 is traveling when the speed of vehicle 200 (vehicle speed) calculated using the positional information is more than or equal to a threshold value. Further, for example, ECU 100 determines that vehicle 200 is in a stopped state (i.e., is not traveling) when the vehicle speed is less than the threshold value. The threshold value is a value for determining whether vehicle 200 is traveling or in a stopped state, and is adapted through experiments and the like. When it is determined that vehicle 200 is traveling (YES in S106), the processing proceeds to S108.

In S108, ECU 100 determines whether there is no cover above vehicle 200. For example, ECU 100 specifies the position of vehicle 200 on a map using the positional information of vehicle 200, and determines whether or not the position of vehicle 200 specified on the map is a position where there is a cover above vehicle 200. For example, when the position of vehicle 200 on the map is a position within a tunnel, a position within an indoor parking area, or a position within an underground parking area, ECU 100 may determine that the position of vehicle 200 is a position where there is a cover above vehicle 200. Alternatively, when there is a cover above vehicle 200 and the amount of insolation is smaller than a threshold value, ECU 100 may determine that the position of vehicle 200 is a position where there is a cover above vehicle 200. When it is determined that the position of vehicle 200 is a position where there is no cover above vehicle 200 (YES in S108), the processing proceeds to S110.

In S110, ECU 100 determines whether or not the position of vehicle 200 is a position where exhaust has no influence. For example, when the position of vehicle 200 is in a predetermined region and a current time is a time within a predetermined time zone, ECU 100 may determine that the position of vehicle 200 is a position where gas exhaust has no influence. The predetermined region (corresponding to a first region) includes a region with a lower degree of influence caused by exhaust of the gas, which is other than a residential section (corresponding to a second region), for example. The predetermined time zone includes time zones such as a night time zone and a midnight time zone with less people. When it is determined that the position of vehicle 200 is a position where exhaust has no influence (YES in S110), the processing proceeds to S112.

In S112, ECU 100 performs gas exhaust processing. The gas exhaust processing includes processing of operating shutter mechanism 260 to establish a flowable state from the one end of first exhaust duct 250 to the other end of second exhaust duct 258. Then, the processing is ended.

It should be noted that this processing is ended when it is determined that the gas concentration within battery pack 214 is not increasing (NO in S100), when it is determined that vehicle 200 is not traveling (that is, in a stopped state) (NO in S106), when it is determined that the position of vehicle 200 is a position where there is a cover above vehicle 200 (NO in S108), or when it is determined that the position of vehicle 200 is a position where exhaust has an influence (NO in S110).

An example of operation of ECU 100 based on a structure and the flowchart as described above will be described.

For example, a case is assumed where a gas is generated in a cell of the battery module within battery pack 214 due to deterioration or the like, and the generated gas flows out through a safety valve of the cell. As the generated gas flowing out of the cell increases, the sulfur component contained in the gas also increases. This results in an increase in the concentration of hydrogen sulfide generated by the sulfur component in the gas flowing out into battery pack 124 and the moisture contained in the air within battery pack 124.

Accordingly, when the gas concentration exceeds the threshold value (YES in S100), the positional information of vehicle 200 is obtained using position detection device 104 (S102), and the amount of insolation to vehicle 200 is obtained using insolation sensor 102 (S104).

When it is determined that vehicle 200 is traveling (YES in S106), the position of vehicle 200 is a position where there is no cover above vehicle 200 (YES in S108), and the position of vehicle 200 is a position where gas exhaust has no influence (YES in S110), the gas exhaust processing is performed (S112).

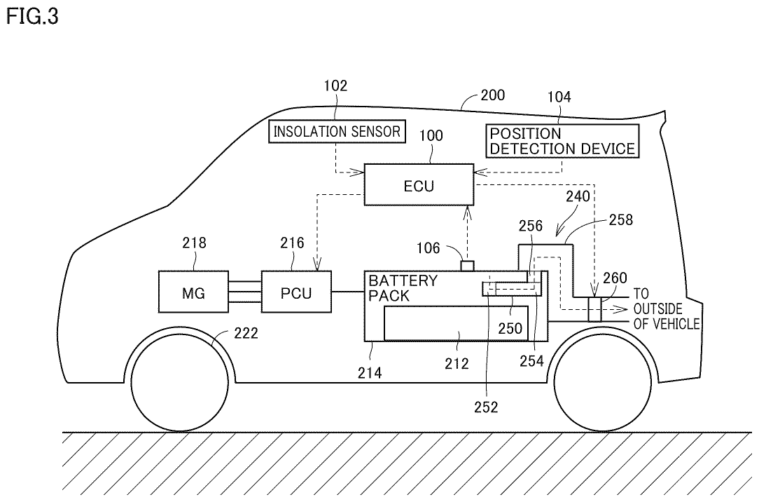

FIG. 3 is a view for illustrating a gas exhaust path. The configuration of vehicle 200 shown in FIG. 3 is the same as the configuration of vehicle 200 shown in FIG. 1. Accordingly, the detailed description thereof will not be repeated.

When the gas exhaust processing is performed, the shutter mechanism switches to the flowable state, and thus communication is established between the outside of the vehicle and the inside of battery pack 214 via first exhaust duct 250 and second exhaust duct 258. Due to an increase in pressure within battery pack 214 caused by the gas generated within battery pack 214, or due to driving of the fan not shown, the gas within battery pack 214 is introduced into first exhaust duct 250. The gas introduced into first exhaust duct 250 flows to the outside of the vehicle via first exhaust duct 250 and second exhaust duct 258, as indicated by a broken-line arrow in FIG. 3. When the gas passes through first filter 252, second filter 256, and desulfurization agent 254, the sulfur component and the like contained in gas are adsorbed, and the gas containing other components is exhausted to the outside of the vehicle.

On the other hand, when it is determined that vehicle 200 is in a stopped state (NO in S106), or vehicle 200 is traveling (YES in S106) and the position of vehicle 200 is a position where there is a cover, such as a tunnel, above vehicle 200 (NO in S108), or the position of vehicle 200 is a position where gas exhaust has an influence (NO in S110), the gas exhaust processing is not performed. In this case, the gas within battery pack 214 is not exhausted to the outside of the vehicle.

As described above, vehicle 200 according to the present embodiment can exhaust the gas to the outside of the vehicle or suppress exhaust according to the traveling state of vehicle 200 or the position of vehicle 200, and thus it can exhaust the gas generated in the battery module which is an all-solid-state battery within battery pack 214 at appropriate timing. Therefore, it is possible to provide a vehicle that can exhaust a gas within a battery pack at appropriate timing, and a method for controlling the vehicle.

In particular, during traveling, the exhausted gas is diffused, and thus the amount of gas within the battery pack can be decreased by exhausting the gas to the outside of the vehicle. Further, in a stopped state, stay of the gas around the vehicle is suppressed by suppressing exhaust of the gas to the outside of the vehicle, which can suppress the retained gas from entering the vehicle.

Furthermore, when it is determined that there is a cover above vehicle 200, it is highly likely that the vehicle is located at a place where there is a wall in any direction around the vehicle, such as a side wall of a tunnel or a side wall of an indoor parking area or the like. Accordingly, by preventing the gas from being exhausted to the outside of the vehicle when there is a cover above vehicle 200, stay of the gas around the vehicle can be suppressed. On the other hand, when there is no cover above vehicle 200, it is less likely that the vehicle is located at a place where there is a wall in any direction around the vehicle. Accordingly, by exhausting the gas to the outside of the vehicle when there is no cover above vehicle 200, occurrence of an influence caused by exhaust of the gas can be suppressed even if the gas is exhausted to the outside of the vehicle. Thereby, an increase in pressure caused by the gas within battery pack 214 can be suppressed.

In the following, variations will be described.

Although the above embodiment has described, as an example, a case where the gas generated from a cell of battery module 212 within battery pack 214 is a gas containing hydrogen sulfide, the gas is not particularly limited to a gas containing hydrogen sulfide.

Further, although the above embodiment has described that the vehicle speed is calculated using position detection device 104, the vehicle speed may be calculated by detecting the speed of the wheels or the like, for example.

Furthermore, although the above embodiment has described, as an example, a case where, when the gas exhaust processing is performed, communication is established between the one end of first exhaust duct 250 and the other end of second exhaust duct 258 via shutter mechanism 260, and the fan is driven to forcibly exhaust the gas within battery pack 214 to the outside of the vehicle, shutter mechanism 260 may be omitted, communication may be established during normal times, and the fan may be driven only when the gas exhaust processing is performed to forcibly exhaust the gas within battery pack 214 to the outside of the vehicle. With such a configuration, since communication is established during normal times, the air flows in and out between the inside of battery pack 214 and the outside of the vehicle, and the pressure within battery pack 214 can be kept constant. Further, since the fan is driven according to the position or the traveling state of vehicle 200 when the gas concentration increases, the gas within battery pack 214 can be exhausted to the outside of the vehicle at appropriate timing. It should be noted that, in this case, also during normal times and when the gas concentration increases, hydrogen sulfide contained in the gas is adsorbed by desulfurization agent 254.

Furthermore, although the above embodiment has described, as an example, a case where the gas within battery pack 214 is exhausted to the outside of the vehicle by establishing communication between the one end of first exhaust duct 250 and the other end of second exhaust duct 258, the amount of gas flow to be exhausted to the outside of the vehicle may be regulated using the fan or a regulating valve, for example.

ECU 100 may regulate the amount of gas flow to be exhausted to the outside of the vehicle based on the vehicle speed, for example. ECU 100 may control the fan or the regulating valve such that the amount of flow is larger as the vehicle speed is faster, and the amount of flow is smaller as the vehicle speed is slower, for example.

With such a configuration, since the exhausted gas is diffused more widely as the vehicle speed is faster, much gas can be exhausted to the outside of the vehicle without having an influence on the surroundings, and the pressure within battery pack 214 can be decreased. Further, since the gas is not diffused widely as the vehicle speed is slower, when compared with a case where the vehicle speed is fast, the gas within battery pack 214 can be exhausted to the outside of the vehicle without having an influence on the surroundings, by appropriately regulating the amount of flow.

Furthermore, although the above embodiment has described that the gas exhaust processing is performed upon satisfaction of a performing condition including a condition that vehicle 200 is traveling, a condition that there is no cover above vehicle 200, and a condition that the position of vehicle 200 is a position where exhaust has no influence, the performing condition is not particularly limited to such a condition. For example, the performing condition may include a condition that there is no obstacle, such as a wall, within a predetermined region with vehicle 200 at its center, instead of the condition that there is no cover above vehicle 200. ECU 100 may determine whether or not there is an obstacle, such as a wall, within the predetermined region with vehicle 200 at its center, using a camera that shoots the surroundings of vehicle 200, ranging sensors provided at a plurality of locations around vehicle 200, or the like, for example. For example, when it is detected using the camera, the ranging sensors, or the like that there is an obstacle, such as a wall or another vehicle, in at least one of a plurality of directions including a front direction, a rear direction, a left direction, a right direction, and the like of vehicle 200, and within a predetermined distance corresponding to each direction from vehicle 200, ECU 100 may determine that there is an obstacle within the predetermined region.

It should be noted that the variations described above may be entirely or partially combined as appropriate for implementation.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A vehicle comprising:
a battery pack having a secondary battery;
an exhaust device configured to exhaust a gas generated from the secondary battery within the battery pack to an outside of the vehicle;
a detection device that detects at least one of a position of the vehicle and a traveling state of the vehicle; and
a control device that controls the exhaust device to exhaust the gas to the outside of the vehicle when a detection result of the detection device is a predetermined detection result.

2. The vehicle according to claim 1, wherein
the detection device detects a vehicle speed, and
the control device controls the exhaust device
to exhaust the gas to the outside of the vehicle when the detected vehicle speed indicates that the vehicle is traveling, and
not to exhaust the gas to the outside of the vehicle when the detected vehicle speed indicates that the vehicle is in a stopped state.

3. The vehicle according to claim 1, wherein
the control device controls the exhaust device
to exhaust the gas to the outside of the vehicle when it is detected that the position of the vehicle is within a first region, and
not to exhaust the gas to the outside of the vehicle when it is detected that the position of the vehicle is within a second region different from the first region,
the first region being preset as a region with a degree of influence caused by exhaust of the gas lower than that in the second region.

4. The vehicle according to claim 1, wherein
the control device controls the exhaust device
to exhaust the gas to the outside of the vehicle when the position of the vehicle is a position where there is no cover above the vehicle, and
not to exhaust the gas to the outside of the vehicle when the position of the vehicle is a position where there is a cover above the vehicle.

5. The vehicle according to claim 1, wherein
the battery pack includes an all-solid-state battery, and
the gas contains hydrogen sulfide.

6. A method for controlling a vehicle equipped with a battery pack having a secondary battery, the vehicle including an exhaust device configured to exhaust a gas generated from the secondary battery within the battery pack to an outside of the vehicle, the method comprising:
detecting at least one of a position of the vehicle and a traveling state of the vehicle; and
controlling the exhaust device to exhaust the gas to the outside of the vehicle when a detection result is a predetermined detection result.
